(19) United States
(12) Patent Application Publication
(10) Pub. No.: US 2026/0109235 A1
(43) Pub. Date: Apr. 23, 2026

(54) VEHICLE BATTERY CHARGING SYSTEM BASED ON EXTERIOR SENSING DATA

(71) Applicant: GM GLOBAL TECHNOLOGY OPERATIONS LLC, Detroit, MI (US)

(72) Inventors: Sai Vishnu ALURU, Commerce Township, MI (US); Gayathri Srinivasan, Rochester Hills, MI (US)

(21) Appl. No.: 18/922,701

(22) Filed: Oct. 22, 2024

(51) Int. Cl. B60L 7/10; B60L 58/20; G06V 20/56

(52) U.S. Cl. CPC B60L 7/10; B60L 58/20; B60L 2240/12; B60L 2240/60; G06V 20/56

(57) ABSTRACT

A charging system for a vehicle includes: power sources; an onboard charging module configured to recharge a selected one or more of the power sources; and a control module. The control module is configured to: determine whether the vehicle is decelerating; in response to determining that the vehicle is decelerating, acquire exterior sensor data from a sensors; based on the exterior sensor data, determine whether the vehicle is in dense surroundings; and based on whether the vehicle is in dense surroundings, enable recharging of the selected one or more of the power sources.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to charging systems for low voltage sources and high voltage sources of energy rechargeable storage systems.

Electric vehicles, such as fully electric vehicles, battery electric vehicles (BEVs), and hybrid electric vehicles including plug-in hybrid electric vehicles (PHEVs), include high-voltage (HV) battery packs. The HV battery packs provide power to HV direct current (DC) loads and to an auxiliary power module that converts a high voltage to a low voltage to charge a low-voltage (LV) power source (or battery). The LV power source is used to power LV DC loads. The HV loads may include motors, which are used for propulsion purposes as well as other HV loads. The LV loads may include, for example, lights, window and seat motors, door locks, infotainment system devices, etc. The HV battery packs may have terminals at, for example, 400V or 800V. The LV power sources may have terminals at, for example, 12V or 48V.

### SUMMARY

A charging system for a vehicle is disclosed. The charging system includes: power sources; an onboard charging module configured to recharge a selected one or more of the power sources; and a control module. The control module is configured to: determine whether the vehicle is decelerating; in response to determining that the vehicle is decelerating, acquire exterior sensor data from a sensors; based on the exterior sensor data, determine whether the vehicle is in dense surroundings; and based on whether the vehicle is in dense surroundings, enable recharging of the selected one or more of the power sources.

In other features, the control module is configured to: determine whether a differential braking force is greater than a set differential threshold; and acquire the exterior sensor data in response to the differential braking force being greater than the set differential threshold.

In other features, the control module is configured to: determine whether a differential speed of the vehicle is negative and has a magnitude greater than a set differential threshold; and acquire the exterior sensor data in response to the differential speed being negative and having a magnitude greater than the set differential threshold.

In other features, the control module is configured to: capture images via one or more exterior facing cameras; perform image recognition on the captured images; and based on a number and type of objects detected in the captured images, determine that the vehicle is in dense surroundings.

In other features, the control module is configured to: generate a point cloud based on an output of one or more Lidar sensors; determine a density of the point cloud; determine a signal-to-noise ratio based on the density; and based on the signal-to-noise ratio, determine that the vehicle is in dense surroundings.

In other features, the control module is configured to: generate a data map based on an output of one or more Radar sensors; detect one or more structural objects based on the data map; determine a signal-to-noise ratio based on detection of the one or more structural objects; and based on the signal-to-noise ratio, determine that the vehicle is in dense surroundings.

In other features, the control module is configured to: receive navigation data; separate out metadata from the navigation data; based on the metadata, determine whether the vehicle is in a construction zone; and determine that the vehicle is in dense surroundings in response to determining that the vehicle is in the construction zone.

In other features, the control module is configured to: in response to determining the vehicle is in dense surroundings, wait for a predetermined period of time; and after the predetermined period of time expiring, enable recharging of the selected one or more of the power sources.

In other features, the control module is configured to: in response to determining the vehicle is in dense surroundings, wait for a first predetermined period of time; in response to the first predetermined period of time expiring, verify that the vehicle is still in dense surroundings; in response to determining the vehicle is still in dense surroundings, wait for a second predetermined period of time; and after the second predetermined period of time expiring, enable recharging of the selected one or more of the power sources.

In other features, the power sources include at least one of a high voltage power source and a lower voltage power source. The high voltage power source supplies a voltage greater than or equal to 200 V. The low voltage power source supplies a voltage less than or equal to 48 V.

In other features, a charging method for charging power sources of a vehicle is disclosed. The charging method includes: determining whether the vehicle is decelerating; in response to determining that the vehicle is decelerating, acquiring exterior sensor data from multiple sensors; based on the exterior sensor data, determining whether the vehicle is in dense surroundings; and based on whether the vehicle is in dense surroundings, enabling recharging of a selected one or more of the power sources via an onboard charging module.

In other features, the charging method further includes: determining whether a differential braking force is greater than a set differential threshold; and acquiring the exterior sensor data in response to the differential braking force being greater than the set differential threshold.

In other features, the charging method further includes: determining whether a differential speed of the vehicle is negative and has a magnitude greater than a set differential threshold; and acquiring the exterior sensor data in response to the differential speed being negative and having a magnitude greater than the set differential threshold.

In other features, the charging method further includes: capturing images via one or more exterior facing cameras; performing image recognition on the captured images; and based on a number and type of objects detected in the captured images, determining that the vehicle is in dense surroundings.

In other features, the charging method further includes: generating a point cloud based on an output of one or more Lidar sensors; determining a density of the point cloud; determining a signal-to-noise ratio based on the density; and based on the signal-to-noise ratio, determining that the vehicle is in dense surroundings.

In other features, the charging method further includes: generating a data map based on an output of one or more Lidar sensors; detecting one or more structural objects based on the data map; determining a signal-to-noise ratio based on detection of the one or more structural objects; and based on the signal-to-noise ratio, determining that the vehicle is in dense surroundings.

In other features, the charging method further includes: receiving navigation data; separating out metadata from the navigation data; based on the metadata, determining whether the vehicle is in a construction zone; and determining that the vehicle is in dense surroundings in response to determining that the vehicle is in the construction zone.

In other features, the charging method further includes: in response to determining the vehicle is in dense surroundings, waiting for a predetermined period of time; and after the predetermined period of time expiring, enabling recharging of the selected one or more of the power sources.

In other features, the charging method further includes: in response to determining the vehicle is in dense surroundings, waiting for a first predetermined period of time; in response to the first predetermined period of time expiring, verifying that the vehicle is still in dense surroundings; in response to determining the vehicle is still in dense surroundings, waiting for a second predetermined period of time; and after the second predetermined period of time expiring, enabling recharging of the selected one or more of the power sources.

In other features, the power sources include at least one of a high voltage power source and a lower voltage power source. The high voltage power source supplies a voltage greater than or equal to 200 V. The low voltage power source supplies a voltage less than or equal to 48 V.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example charging system of a vehicle including a vehicle integration control module in accordance with the present disclosure;

FIG. 2 is a functional block diagram of a portion of the vehicle of FIG. 1 including the vehicle integration control module in accordance with the present disclosure; and

FIGS. 3A-3C illustrate a charging method in accordance with the present disclosure.

In the drawings, reference numbers may be reused to identify similar and/or identical elements.

### DETAILED DESCRIPTION

Electric and hybrid vehicles can include large battery packs, which include battery pack modules with numerous battery cells. The cells of each of the battery pack modules may be connected in series and/or parallel. The battery pack modules may also be connected in series or in parallel to provide various output voltages, such as 12V and 48V to power low-voltage loads such as 12V loads and 48V loads. The battery pack modules may also be connected in series or in parallel for higher voltages such as 400V, 800V and voltages above 800V. Separate and designated battery pack(s) may be provided for low-voltage and high-voltage loads.

During operation, parameters such as voltage, current, and temperature of battery pack modules and cells may be monitored to determine SOX values of the battery pack modules and cells. The acronym “SOX” refers to a state of charge (SOC), a state of health (SOH), state of power (SOP), and/or a state of function (SOF). The SOC of a cell and/or battery pack module may refer to the voltage, current and/or amount of available power stored in the cell and/or battery pack module. The SOH of a cell and/or battery pack module may refer to: the age (or operating hours); whether there is a short circuit; whether there is a loose wire or bad connection; temperatures, voltages, power levels, and/or current levels supplied to or sourced from the cell and/or battery pack module during certain operating conditions; and/or other parameters describing the health of the cell and/or battery pack module. The SOF of a cell and/or battery pack module may refer to a current temperature, voltage, and/or current level supplied to or sourced from the cell and/or battery pack module, and/or other parameters describing a current functional state of the cell and/or battery pack module.

The implementations disclosed herein may be applied to fully electric vehicles, BEVs, hybrid electric vehicles including PHEVs, partially or fully autonomous vehicles, and other types of vehicles.

The term “power source” as used herein may refer to a battery pack, a battery module of a battery pack, one or more cells of a battery module of a battery pack, a battery, and/or other rechargeable power source. A battery pack may include multiple battery modules, which in turn may each include hundreds of cells. Thus, a power source may include multiple power sources. A power source may further include a cooling circuit, sensors, switches, terminals, a control module, etc.

The examples set forth herein include a charging system for charging high-voltage (HV) and low-voltage (LV) battery packs of a vehicle. The charging is performed based on exterior sensor data from, for example, cameras, Lidar sensors, Radar sensors, and a navigation system. The charging system leverages reliable data points from externally facing sensor modules to drive charge efficiency management. Charge efficiency management includes a regeneration strategy that includes charging HV and LV battery packs while supporting vehicle operations that are implemented using HV and LV power.

A charging system may operate based on vehicle dynamics, such as vehicle speed and braking pattern, along with calibrations for charge efficiency management. However, such a charging system can be efficiency limited. The charging system disclosed herein operates based on vehicle dynamics, current braking operations, and externally perceived pre-processed sensor data to enable additional reinforcement for the charge efficiency and thereby leading to battery heal management and extended battery life. In an embodiment, real time analysis of sensor data of an environment surrounding a host vehicle is performed based on which charging of HV and LV battery packs is implemented for improved charging efficiency.

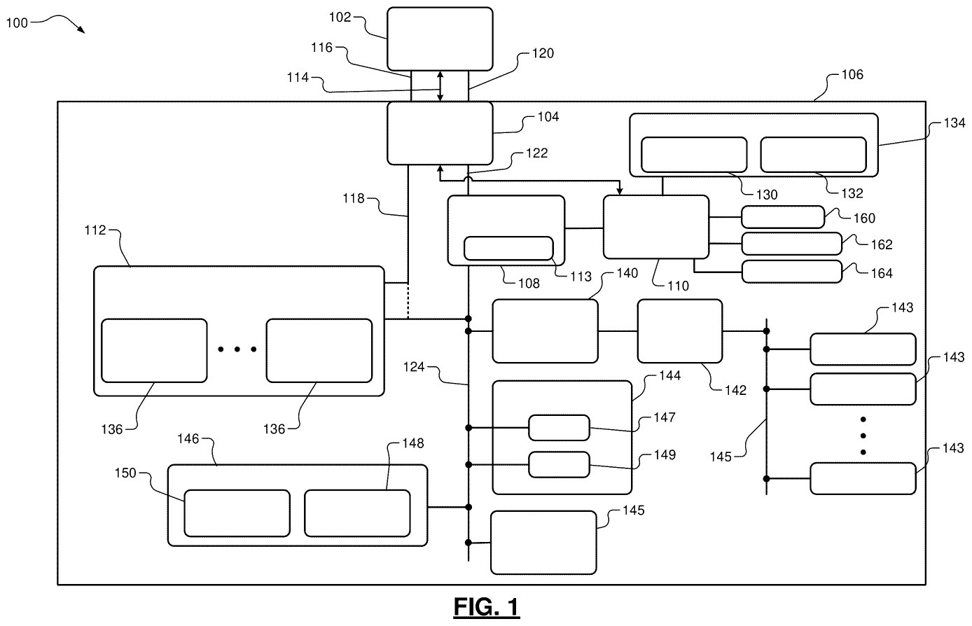

FIG. 1 shows a charging system 100 that may include an offboard charging station 102, a charging receptacle 104 of a vehicle 106, an onboard charging module (OBCM) 108, a vehicle integration control module (VICM) 110, and a rechargeable storage system (RESS) 112. The OBCM 108 includes an AC-to-DC converter 113 that converts HV AC to HV DC. The OBCM 108 controls an amount of current and power on the HV DC bus 124, a portion of which makes it to the RESS 112 during charging of the RESS 112. The OBCM 108 receives an AC voltage from the offboard charging station 102 and reports the AC voltage to the VICM 110. The OBCM 108 may regulate the voltage on the HV DC bus 124. The OBCM 108 may also be part of a regenerative braking system, for recharging power sources during vehicle braking.

The VICM 110 communicates with the offboard charging station 102 via a communication line 114 and controls charging of the RESS 112 i) directly via a first HV DC line 116 and a second HV DC line 118, or ii) indirectly via a HV AC line 120, the OBCM 108, a line 122 between the charging receptacle 104 and the OBCM 108, and a HV DC bus 124. The communication may include determining charge capabilities of the offboard charging station 102 and may include instructions for setting power outputs of the offboard charging station 102. The HV DC line 118 may be connected to the HV DC bus 124. The VICM 210 implements a charging application 130 based on calibration values, at least some of which are referred to herein, which are stored in memory 134. The RESS 112 may include one or more HV battery packs 136, which may be connected in series and/or parallel.

The vehicle 106 further includes an auxiliary power module (APM) 140, a heating ventilation and air-conditioning (HVAC) system 144, a propulsion system 146, and/or other HV power sources. The APM 140 may convert the HV DC on the HV DC bus 124 to a LV DC and provide the LV DC to a LV power source 142 (e.g., a 12 V battery, a multiple output dynamically adjustable capacity system (MODACS), a 48 V power source, etc.). The LV power source 142 may have one or more positive terminals at one or more positive voltage potentials (e.g., 12 V and 48 V). The LV power source 142 supplies power to LV systems and/or devices 143, such as lighting systems, infotainment systems, navigation systems, object detection and/or collision avoidance systems, seat heaters and/or motors, window motors, door locks, etc. Although a single LV DC bus 145 is shown, more than one LV DC bus may be included. The HVAC system 144 may include a coolant electric heater (CEH) 147 and an air compressor electric compressor (ACEC) 149. The propulsion system 146 may include one or more motors 148 and may include an internal combustion engine 150, which are used to drive one or more axles and corresponding wheels of the vehicle 106.

A “charging event” may refer to each time the vehicle 106 is plugged into a charging station, such as the offboard charging station 102 or when the VICM 110 recharges one or more of the power sources such as the battery packs 136 and the LV power source 142.

The offboard charging station 102 may be a L1, L2 or L3 type charging station. The VICM 110 may implement recharging events based on information collected from sensors 160, a global positioning system (GPS) receiver 162, and a MAP module 164. The sensors 160 may include voltage sensors, current sensors, temperature sensors, exterior sensors, etc. The exterior sensors may include cameras, Lidar sensors, Radar sensors, and a navigation system, which may include the GPS receiver 162 and the MAP module 164.

The current and voltage sensors may detect current and/or voltages of loads (e.g., loads 143, 147, 149, etc.), HV DC bus 124, LV DC bus 145, etc. The current and voltage sensors may detect current supplied to the RESS 112 and/or voltages of the RESS 112. The current and voltage sensors may detect current drawn from the offboard charging station 102 and/or voltage provided by the offboard charging station 102.

The GPS receiver 162 may provide vehicle location information. The MAP module 164 may provide map information and/or charging station information, such as: charging station type information for the location of the offboard charging station 102; whether the charging station is a public charging station; and/or whether the charging station has a time-based cost for charging. The map information may also or alternatively indicate whether the vehicle 106 and/or offboard charging station 102 is in a parking structure. The VICM 110 may determine when to recharge power sources and/or determine the type of the offboard charging station 102 based on this information. As an example, if the offboard charging station is located in a parking structure, then the offboard charging station may be determined to be a public charging station with a time-based cost for charging. Alternatively, the VICM 110 may determine through communication with the offboard charging station and/or with another network device the type and/or characteristics of the offboard charging station 102. This may include whether the offboard charging station 102 is a public or private charging station and/or whether the offboard charging station 102 has a time-based cost for charging.

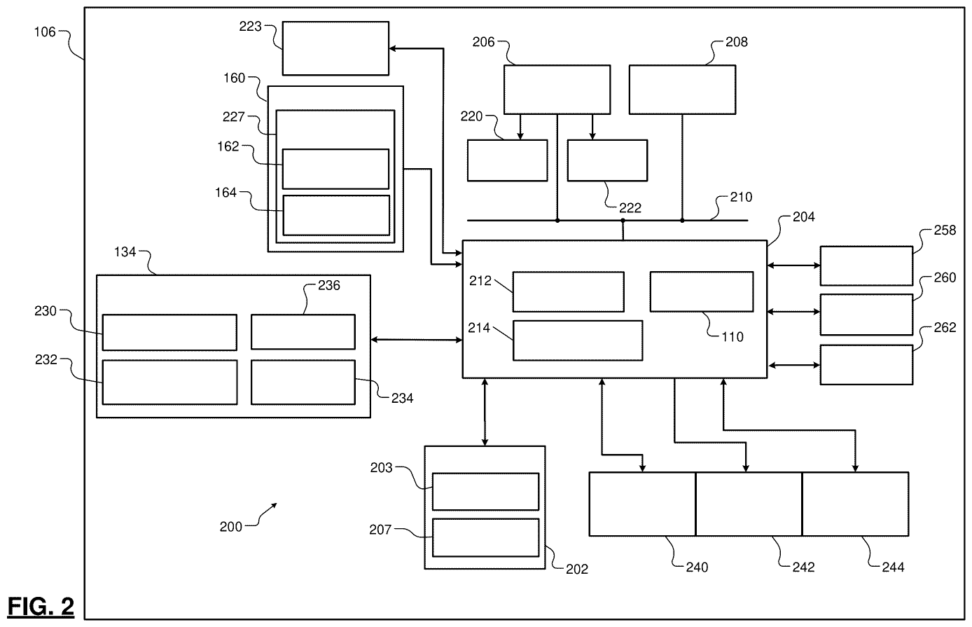

FIG. 2 shows the vehicle 106 including an advanced driver assistance system (ADAS) 200 including the VICM 110, which may be implemented by a vehicle control module 204 or may be a standalone module. The vehicle 106 may include power sources 202 with battery packs 203 and a control circuit 207. The battery packs 203 may include, for example, the battery packs 136 and the LV power sources 142 of FIG. 1. The vehicle 106 further includes an infotainment module 206 and other control modules 208. The control circuit 207 may be implemented as part of the power sources 202 or separate from the power sources 202.

The modules 204, 206, 208 may communicate with each other via one or more buses 210, such as a controller area network (CAN) bus and/or other suitable interfaces. The vehicle control module 204 may control operation of vehicles systems. The vehicle control module 204 may include a mode selection module 212, a parameter adjustment module 214, as well as other modules. The mode selection module 212 may select a vehicle operating mode, such as one of the vehicle operating modes stated above. The parameter adjustment module 214 may be used to adjust parameters of the vehicle 106.

The vehicle 106 may further include: the memory 134; a display 220; an audio system 222; one or more transceivers 223; the sensors 160 including a navigation system 227 with the GPS receiver 162 and MAP module 164. The sensors 160 may include cameras, Lidar sensors, Radar sensors, objection detection sensors, temperature sensors, accelerometers, a vehicle speed (or velocity) sensor, and/or other sensors. The GPS receiver 162 may provide vehicle velocity and/or direction (or heading) of the vehicle and/or global clock timing information.

The memory 134 may store sensor data 230 and/or vehicle parameters 232, applications 236 (e.g., the charging application 130), and calibration values 234. The applications 236 may include applications executed by the modules 110, 204, 206, 208. Although the memory 134 and the vehicle control module 204 are shown as separate devices, the memory 134 and the vehicle control module 204 may be implemented as a single device.

The VICM 110 may monitor states of the sensors 160, the power sources 202, and the braking system 258 and based on this information control timing and duration of recharge events for the power sources 202. This may be based on the charge states of the power sources 202. In an embodiment, each power source has a respective set threshold indicative of whether the respective power source has a low charge state. As an example, when a charge state of a first power source is below a first set threshold indicative of a low charge state for the first power source and a second power source is not below a second set threshold indicative of a low charge state for the second power source, then the VICM 110 recharges the first power source and refrains from recharging the second power source. This may be independent of whether the power source is a HV power source or a LV power source. In an embodiment, when a HV power source and a LV power source are charged above their respective set thresholds, then the HV power source is charged during a recharge event. This is further described below.

The vehicle control module 204 may control operation of an engine 240, a converter/generator 242, a transmission 244, a braking system 258, electric motors 260 and/or a steering system 262 according to parameters set by the modules 110, 204, 206, 208. The braking system 258 may be a regenerative braking system that supplies power to, for example, the onboard charging module 108 of FIG. 1 to recharge the power sources 202. The vehicle control module 204 may set some of the parameters based on signals received from the sensors 160. The vehicle control module 204 may receive power from the power sources 202, which may be provided to the engine 240, the converter/generator 242, the transmission 244, the brake system 258, the electric motors 260 and/or the steering system 262, etc. Some of the vehicle control operations may include enabling fuel and spark of the engine 240, starting the electric motors 260, powering any of the systems 258, 262, and/or performing other operations as are further described herein.

The engine 240, the converter/generator 242, the transmission 244, the brake system 258, the electric motors 260 and/or the steering system 262 may include actuators controlled by the vehicle control module 204 to, for example, adjust fuel, spark, air flow, brake pressure, steering wheel angle, throttle position, pedal position, etc. This control may be based on the outputs of the sensors 160, the navigation system 227, the GPS receiver 162 and the above-stated data and information stored in the memory 134.

The vehicle control module 204 may determine various parameters including a vehicle speed, an engine speed, an engine torque, a gear state, an accelerometer position, a brake pedal position, an amount of regenerative (charge) power, an amount of boost (discharge) power, an amount of auto start/stop discharge power, and/or other information, such as: priority levels of source terminals of the power sources 202; power, current and voltage demands for each source terminal; etc. The vehicle control module 204 may share this information and the vehicle operating mode with the control circuit 207. The control circuit 207 may determine other parameters, such as: an amount of charge power at each source terminal; an amount of discharge power at each source terminal; maximum and minimum forces at cells, blocks, packs, and/or groups; maximum and minimum voltages at source terminals; maximum and minimum voltages at power rails, cells, blocks, packs, and/or groups; SOX values of cells, blocks, packs, and/or groups; temperatures of cells, blocks, packs, and/or groups; current values of cells, blocks, packs, and/or groups; power values of cells, blocks, packs, and/or groups; etc. The control circuit 207 may determine connected configurations of the cells and corresponding switch states as described herein based on the parameters determined by the vehicle control module 204 and/or the control circuit 207.

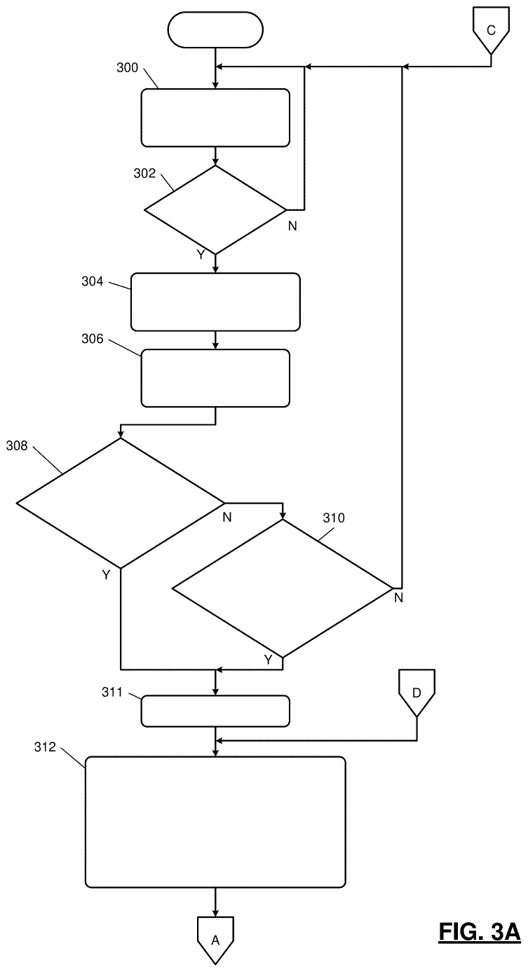

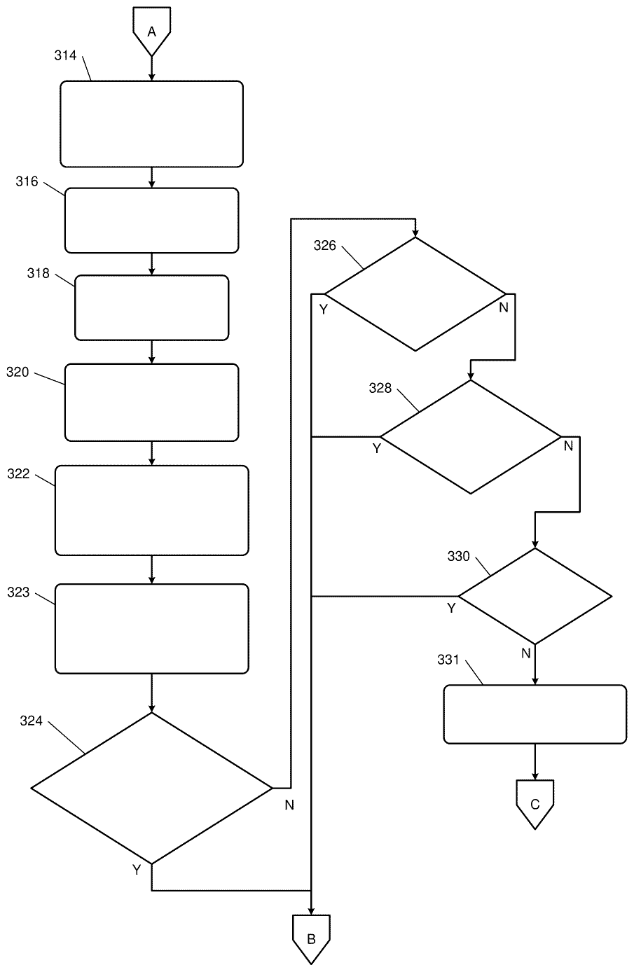

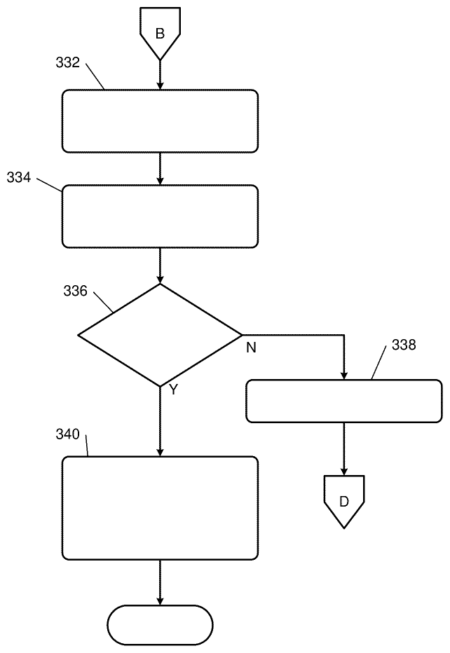

FIGS. 3A-3C show a charging method that may be implemented by, for example, the charging system 100 of FIG. 1 and corresponding modules, devices, and systems of FIGS. 1-2. The operations of the charging method may be iteratively performed. Although the operations are primarily described as being performed by the VICM 110 of FIGS. 1-2, one or more of the operations may be performed by another module, such as the onboard charging module 108 of FIG. 1 and/or the vehicle control module 204 of FIG. 2. Some of the following operations refer to thresholds and a predetermined distance, which may each be a calibratable value that can be adjusted.

At 300, the VICM 110 acquires vehicle state information and sensor data. The vehicle state information may include indications of whether the vehicle is turned on, stationary, moving, etc. The sensor data may include sensor data from any of the sensors referred to herein including vehicle speed data and brake system data. The brake system data may include requested brake force values, actual applied brake force values, a total amount of brake force being applied, etc. A brake force value may be provided for the entire braking system or for each brake of the braking system, such as the brake force values respectively at the wheels of the host vehicle.

At 302, the VICM 110 may determine whether the host vehicle is in a propulsion mode. The propulsion mode refers to when the host vehicle is moving (i.e., not stationary). If in the propulsion mode, operation 304 may be performed, otherwise the method may return to operation 300.

At 304, the VICM 110 may determine a differential braking force over a set period of time. The differential braking force refers to a difference between a first amount of braking force at a first time and a second amount of braking force at a second time. The second time occurs after the first time. The differential braking force is equal to the second amount of braking force minus the first amount of braking force. In an embodiment, the differential braking force refers to a difference in a total amount of braking force. In another embodiment, a braking pattern of the host vehicle is monitored and a change in an amount of braking force is calculated. The differential braking force may be based on a number of brakes applied at each wheel of the host vehicle and/or the amount of braking force applied at each wheel.

At 306, the VICM 110 may determine a differential vehicle speed over the set period of time. The differential vehicle speed refers to a difference in vehicle speed between a first vehicle speed at a first time and a second vehicle speed at a second time. The second time occurs after the first time. The differential vehicle speed is equal to the second vehicle speed minus the first vehicle speed.

At 308, the VICM 110 may determine whether the differential braking force is greater than a first set differential threshold. The VICM 110 monitors the braking pattern of the vehicle including amounts of brake force applied at each wheel of the vehicle. If not, operation 310 is performed, otherwise operation 307 may be performed.

At 310, the VICM 110 may determine whether the differential vehicle speed is greater than a second set differential threshold. If not, operation 300 may be performed, otherwise operation 307 may be performed. In an embodiment, operation 311 is performed only if the differential braking force is greater than the first differential threshold independent of the differential vehicle speed.

At 311, the VICM 110 may initialize a wait counter. For example, the wait counter may be set equal to 1 indicative that this is the first iteration of the operations 312, 314, 316, 318, 320, 322, 323, 324, 326, 328, 330, 331, 332, 334 and thus the wait period of operation 334 is being implemented a first time.

At 312, the VICM 110 acquires sensor data via ADAS system sensors, such as the camera, Lidar, a Radar sensors and navigation system. This may include: capturing images via exterior facing cameras of the host vehicle; generating and acquiring a point cloud via one or more Lidar sensors; acquiring Radar data and generating a data map based on the Radar data; and collecting navigation system metadata in layers. The navigation system metadata may be separated from other navigation system data. The metadata is data that provides information about other navigation data. In an embodiment, the sensor data is prioritized and based on the prioritization, is used in the following operations to determine a charging strategy. In an embodiment, the sensor data is processed independently.

At 314, the VICM 110 performs object recognition based on the captured images including recognition of objects surrounding or within the predetermined distance (e.g., 100-1500 meters) of the host vehicle. This includes detecting construction cones, other vehicles, construction barricades, construction signs, etc. Obstruction data of the objects is collected and analyzed. Each of the detected objects may be graded based on confidence levels in the type and location of each object. The grading may also be based on relevancy of each object with regards to whether the host vehicle is in an object dense environment further indicative of whether the host vehicle will be braking for an extended period of time. An object dense environment may refer to an environment within the predetermined distance of the host vehicle in which there are: more than a predetermined number of objects; more than a predetermined number of objects of a certain type; and/or more than predetermined numbers respectively of certain types of objects.

At 316, the VICM 110 determines a density of the point cloud to generate obstruction data associated with one or more objects. The point cloud density is the number of point coordinates collected per unit area. The higher the density, the more likely there is an object, such as another vehicle. At 318, the VICM 110 determines a first signal to noise ratio (SNR) based on the point cloud density.

At 320, the VICM 110 detects a tunnel, an accident, a bridge, a metal object, or other nearby structure based on the data map generated based on the Radar data. The structure being one that would typically have vehicles and other objects in close vicinity of each other and moving at a reduced or slow speed and thus cause the host vehicle to brake and have a reduction in speed.

At 322, the VICM 110 determines a second SNR based on the data map for the Radar data associated with the detected structure. The second SNR of the Radar data may be calculated on a per pulse basis and this value is then multiplied by the number of pulses integrated to obtain the second SNR for a given duration of target illumination.

At 323, the VICM 110 may collect construction zone information, congestion (or traffic) information details, accident information, travel information (e.g., vehicle travel times), etc. based on the navigation system data and metadata.

At 324, the VICM 110 determines whether there are more than a predetermined number of objects (e.g., 10-30 objects) within the predetermined distance of the host vehicle. As an example, the objects may include other vehicles, construction or traffic cones, pedestrians, etc. If not, operation 326 may be performed, otherwise operation 332 may be performed.

At 326, the VICM 110 determines whether the first SNR is greater than a first SNR threshold (e.g., 15-30 decibels (dB)). If not, operation 328 may be performed, otherwise operation 332 may be performed.

At 328, the VICM 110 determines whether the second SNR is greater than a second SNR threshold (e.g., 10-20 dB). If not, operation 330 may be performed, otherwise operation 332 may be performed.

At 330, the VICM 110 determines whether the host vehicle is in a construction zone. If not, operation 331 may be performed, otherwise operation 332 may be performed. At 331, the VICM 110 may set a flag indicative that the host vehicle is not in dense surroundings. The VICM 110 may then return to operation 300 after operation 331.

At 332, the VICM 110 may set a flag indicative that the host vehicle is in dense surroundings. In an embodiment, this occurs when the above collected data is confirmed. This may occur when results of one or more of operations 324, 326, 328 and 330 is yes (or TRUE).

At 334, the VICM 110 waits for a predetermined period of time (e.g., 1-5 minutes). The predetermined period of time may be based on the speed of the vehicle. As an example, the predetermined period of time may be an amount of time for a first speed and a second amount of time for a second speed. The first speed being greater than the second speed and the second amount of time being greater than the first amount of time. The VICM 110 waits the predetermined period of time (or calibratable duration) to improve reliability in an indication that the vehicle is in dense surroundings. In an embodiment, the predetermined period of time is different for each setting of the wait counter. As an example, a first predetermined period of time (e.g., five minutes) for a first iteration of operation 334 and a second predetermined period of time (e.g., 2 minutes) for a second iteration of operation 334. Each subsequent iteration may have a further reduced predetermined period (or wait period).

At 336, the VICM 110 determines whether the wait counter is greater than a predetermined threshold. If not, operation 338 may be performed, otherwise operation 340 may be performed. The predetermined threshold may be an integer number (e.g., 1-3).

At 338, the VICM 110 increments the wait counter.

At 340, the VICM 110 enables a regeneration strategy to recharge one or more of the battery packs of one or more power sources, such as any of the power sources referred to herein. As an example, a battery pack may be charged when a SOC of the battery back is less than 78%. In an embodiment, the battery pack with the lowest SOC, is charged. In an embodiment, when HV and LV battery packs are each above respective predetermined charged thresholds (e.g., 75-80%), the HV battery packs are charged. The VICM 110 monitors SOCs of the HV and LV battery packs and selects one or more battery packs to charge.

The method may end subsequent to operation 340 as shown or return to operation 300.

The above-described operations are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

In an embodiment, activation of a regeneration strategy is implemented based on one or more calibrated thresholds over a software stack of the VICM 110. The parameters obtained based on outputs of exterior sensors are used to expand the lifecycle battery packs. Camera, Lidar and Radar based data about the surroundings of a vehicle are used in real-time to adaptively activate a regeneration strategy to improve lifecycle of battery packs.

In an embodiment of the above method, camera, Lidar and Radar data is analyzed to process host vehicle surrounding details to determine if the host vehicle is in dense surroundings. A criteria is utilized such as a determination of whether: the host vehicle is experiencing stop-and-go-traffic and is surrounded by 10 or more vehicles around sides of the host vehicle; the host vehicle is in an identified construction zone; or host vehicle speed is consistently less than a threshold (e.g., 15 miles-per-hour (mph)) over a predetermined period (e.g., 10 minutes). Data processed based on the criteria shall is used to enable regenerative charging functionality.

In an embodiment, enabling a regeneration strategy automatically enables channeling unused excess energy generated by the auxiliary power module, which may be implemented as one or more generators, to cater to loads on a LV grid within the host vehicle. Additionally, during this event excess power from the internal combustion engine and/or auxiliary power module stored in the RESS is used to charge the LV power source (or LV batteries) on the LV grid.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A charging system for a vehicle, the charging system comprising:
a plurality of power sources;
an onboard charging module configured to recharge a selected one or more of the plurality of power sources; and
a control module configured to
determine whether the vehicle is decelerating,
in response to determining that the vehicle is decelerating, acquire exterior sensor data from a plurality of sensors,
based on the exterior sensor data, determine whether the vehicle is in dense surroundings, and
based on whether the vehicle is in dense surroundings, enable recharging of the selected one or more of the plurality of power sources.

2. The charging system of claim 1, wherein the control module is configured to:
determine whether a differential braking force is greater than a set differential threshold; and
acquire the exterior sensor data in response to the differential braking force being greater than the set differential threshold.

3. The charging system of claim 1, wherein the control module is configured to:
determine whether a differential speed of the vehicle is negative and has a magnitude greater than a set differential threshold; and
acquire the exterior sensor data in response to the differential speed being negative and having a magnitude greater than the set differential threshold.

4. The charging system of claim 1, wherein the control module is configured to:
capture images via one or more exterior facing cameras;
perform image recognition on the captured images; and
based on a number and type of objects detected in the captured images, determine that the vehicle is in dense surroundings.

5. The charging system of claim 1, wherein the control module is configured to:
generate a point cloud based on an output of one or more Lidar sensors;
determine a density of the point cloud;
determine a signal-to-noise ratio based on the density; and
based on the signal-to-noise ratio, determine that the vehicle is in dense surroundings.

6. The charging system of claim 1, wherein the control module is configured to:
generate a data map based on an output of one or more Radar sensors;
detect one or more structural objects based on the data map;
determine a signal-to-noise ratio based on detection of the one or more structural objects; and
based on the signal-to-noise ratio, determine that the vehicle is in dense surroundings.

7. The charging system of claim 1, wherein the control module is configured to:
receive navigation data;
separate out metadata from the navigation data;
based on the metadata, determine whether the vehicle is in a construction zone; and
determine that the vehicle is in dense surroundings in response to determining that the vehicle is in the construction zone.

8. The charging system of claim 1, wherein the control module is configured to:
in response to determining the vehicle is in dense surroundings, wait for a predetermined period of time; and
after the predetermined period of time expiring, enable recharging of the selected one or more of the plurality of power sources.

9. The charging system of claim 1, wherein the control module is configured to:
in response to determining the vehicle is in dense surroundings, wait for a first predetermined period of time;
in response to the first predetermined period of time expiring, verify that the vehicle is still in dense surroundings;
in response to determining the vehicle is still in dense surroundings, wait for a second predetermined period of time; and
after the second predetermined period of time expiring, enable recharging of the selected one or more of the plurality of power sources.

10. The charging system of claim 1, wherein:
the plurality of power sources comprise at least one of a high voltage power source and a lower voltage power source;
the high voltage power source supplies a voltage greater than or equal to 200 V; and
the low voltage power source supplies a voltage less than or equal to 48 V.

11. A charging method for charging a plurality of power sources of a vehicle, the charging method comprising:
determining whether the vehicle is decelerating;
in response to determining that the vehicle is decelerating, acquiring exterior sensor data from a plurality of sensors;
based on the exterior sensor data, determining whether the vehicle is in dense surroundings; and
based on whether the vehicle is in dense surroundings, enabling recharging of a selected one or more of the plurality of power sources via an onboard charging module.

12. The charging method of claim 11, further comprising:
determining whether a differential braking force is greater than a set differential threshold; and
acquiring the exterior sensor data in response to the differential braking force being greater than the set differential threshold.

13. The charging method of claim 11, further comprising:
determining whether a differential speed of the vehicle is negative and has a magnitude greater than a set differential threshold; and
acquiring the exterior sensor data in response to the differential speed being negative and having a magnitude greater than the set differential threshold.

14. The charging method of claim 11, further comprising:
capturing images via one or more exterior facing cameras;
performing image recognition on the captured images; and
based on a number and type of objects detected in the captured images, determining that the vehicle is in dense surroundings.

15. The charging method of claim 11, further comprising:
generating a point cloud based on an output of one or more Lidar sensors;
determining a density of the point cloud;
determining a signal-to-noise ratio based on the density; and
based on the signal-to-noise ratio, determining that the vehicle is in dense surroundings.

16. The charging method of claim 11, further comprising:
generating a data map based on an output of one or more Lidar sensors;
detecting one or more structural objects based on the data map;
determining a signal-to-noise ratio based on detection of the one or more structural objects; and
based on the signal-to-noise ratio, determining that the vehicle is in dense surroundings.

17. The charging method of claim 11, further comprising:
receiving navigation data;
separating out metadata from the navigation data;
based on the metadata, determining whether the vehicle is in a construction zone; and
determining that the vehicle is in dense surroundings in response to determining that the vehicle is in the construction zone.

18. The charging method of claim 11, further comprising:
in response to determining the vehicle is in dense surroundings, waiting for a predetermined period of time; and
after the predetermined period of time expiring, enabling recharging of the selected one or more of the plurality of power sources.

19. The charging method of claim 11, further comprising:
in response to determining the vehicle is in dense surroundings, waiting for a first predetermined period of time;
in response to the first predetermined period of time expiring, verifying that the vehicle is still in dense surroundings;
in response to determining the vehicle is still in dense surroundings, waiting for a second predetermined period of time; and
after the second predetermined period of time expiring, enabling recharging of the selected one or more of the plurality of power sources.

20. The charging method of claim 11, wherein:
the plurality of power sources comprise at least one of a high voltage power source and a lower voltage power source;
the high voltage power source supplies a voltage greater than or equal to 200 V; and
the low voltage power source supplies a voltage less than or equal to 48 V.
